(19) United States
(12) Patent Application Publication
(10) Pub. No.: US 2010/0000149 A1
(43) Pub. Date: Jan. 7, 2010

(54) Coir Fibre Rope, Plant Liner, Pot and Insulating Product

(76) Inventors: Jean Marc Ouellet, Lindsay (CA); Yohan Suriyampola, Burlington (CA)

Correspondence Address: HODGSON RUSS LLP;THE GUARANTY BUILDING, 140 PEARL STREET, SUITE 100, BUFFALO, NY, 14202-4040, US

(21) Appl. No.: 12/344,694

(22) Filed: Dec. 29, 2008

Related U.S. Application Data
(60) Provisional application No. 61/016,860, filed on Dec. 27, 2007.

(51) Int. Cl. A01G 13/02; A01G 9/02; B29D 31/00

(52) U.S. Cl. 47/32.7; 47/65.8; 264/243

(57) ABSTRACT

A tree liner is formed from a composition of a sheet of brown coir to which a latex mixture is applied, preferably by spraying. The tree-liner may be inserted in a wire basket and used to wrap, cover and/or protect the roots of young trees and bushes during the lifting, preparation, packaging and shipping process from the nursery to the final user. The tree-liner comprises approximately 80% coir and 20% latex composition by weight. There is also provided a standalone plant container formed from a sheet of the same coir/latex composition. The composition may also be used for bedding, insulation and other various applications.

### FIELD OF THE INVENTION

This invention relates to the use of coir fibre, and in particular brown coir, as a rope for horticultural applications and as an ingredient in a liner for plant roots, as a plant pot, as a stuffing for bedding and as an insulative product.

### BACKGROUND OF THE INVENTION

Coir fibres are found between the husk and the outer shell of a coconut. The individual fibre cells are narrow and hollow, with thick walls made of cellulose. Brown coir is typically used in mats, brushes and sacking and is harvested from fully ripened coconuts. It is thick, strong and has high abrasion resistance. Mature brown coir fibres are stronger than alternate sources of fibre material such as flax or cotton as they contain more lignin and less cellulose. Brown coir is made up of small threads, each about 1 mm long and 10 to 20 micrometres in diameter.

White coir fibres are harvested from the coconuts before they are ripe. These fibres are white or light brown in color and are smoother and finer, but also weaker. They are generally spun to make yarn that is used in mats or rope.

Coir fibre is known to be relatively water-proof and is one of the few natural fibres resistant to damage by salt water. Fresh water is used to process brown coir, while sea water and fresh water are both used in the production of white coir.

Given the above properties brown coir fibre is a desirable material for various industrial applications.

### SUMMARY OF THE INVENTION

In accordance with an aspect of the invention there is provided an enhanced rope comprised exclusively of brown coir fibre preferably for the deliberate use with the tree liner as discussed herein. It should be understood that this rope may have other applications and the invention contemplates use with such applications.

In accordance with a further aspect of the invention, there is provided a tree liner comprising a sheet of brown coir to which a latex mixture is applied, preferably by spraying. In an example application, the tree-liner may be inserted in a wire basket, tied with the aforesaid enhanced rope and used to wrap, cover and/or protect the roots of young trees and bushes during the lifting, preparation and shipping process from the nursery to the final user. Preferably the tree-liner of the herein invention comprises approximately 80% coir and 20% latex composition by weight. In accordance with a further aspect of the invention, there is provided a method of manufacturing same, as described by example below.

In accordance with a further aspect of the invention, there is provided a plant container comprising a sheet having a composition of coir and latex as above, wherein the sheet is formed into a plant pot shape. In accordance with an aspect of the invention handles are formed of coir rope, which extend and are formed within the plant pot shaped sheet.

In accordance with a further aspect of the invention, the sheet having the composition of coir and latex as above is used as a stuffing for bedding, or as a home insulation product.

In accordance with a further aspect of the invention, a sheet having a composition of coir and latex is formed into a hot beverage cup/container.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinbelow.

### BRIEF DESCRIPTION OF THE INVENTION

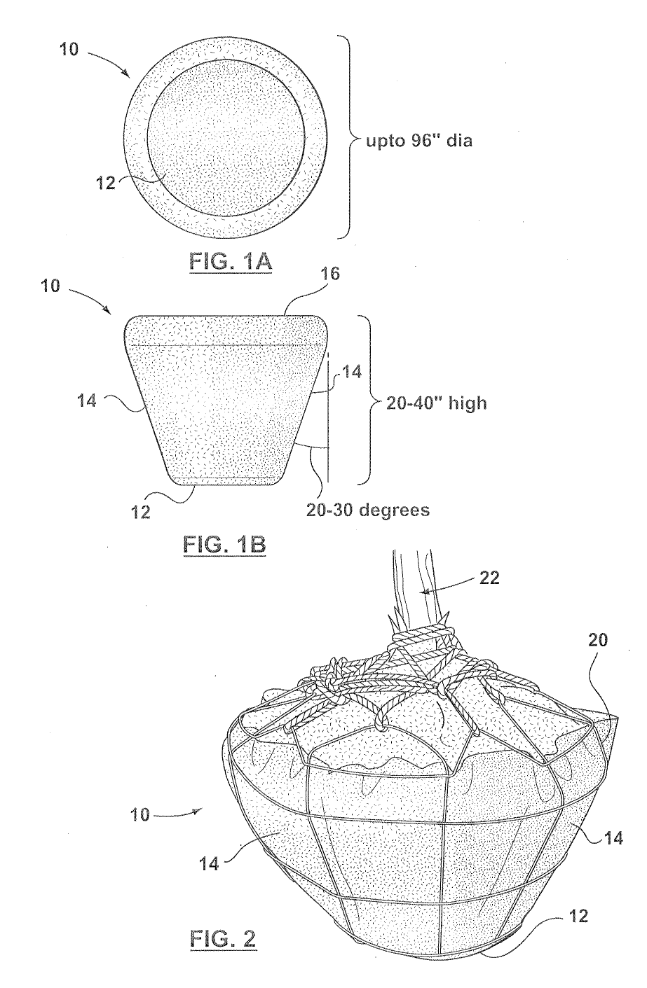

FIGS. 1A and 1B show a bottom view and side view, respectively, of an example embodiment of a tree-liner in accordance with an aspect of the invention.

FIG. 2 illustrates an example embodiment of the tree-liner inserted into a wire basket and tied thereto using an example of the enhanced rope in accordance with an aspect of the invention.

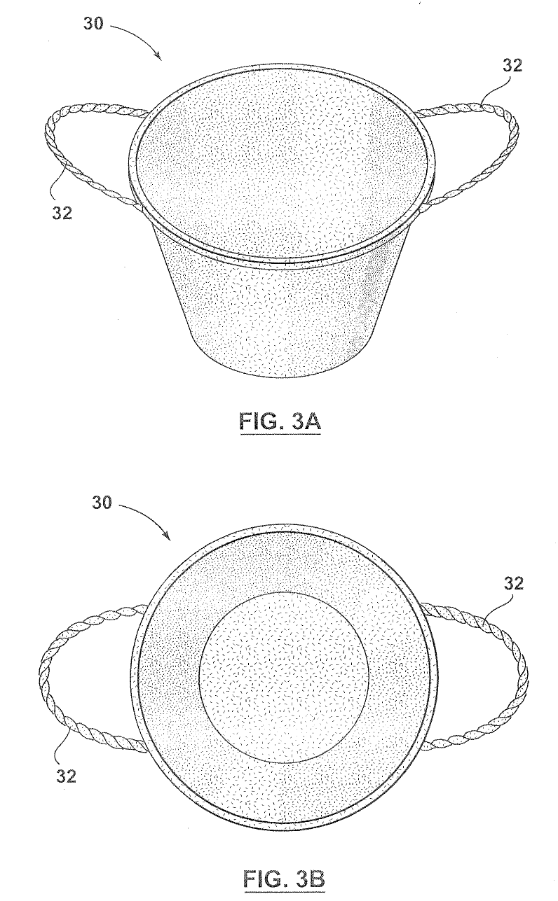

FIGS. 3A and 3B show a perspective and side view, respectively, of an example coir plant container in accordance with an aspect of the invention.

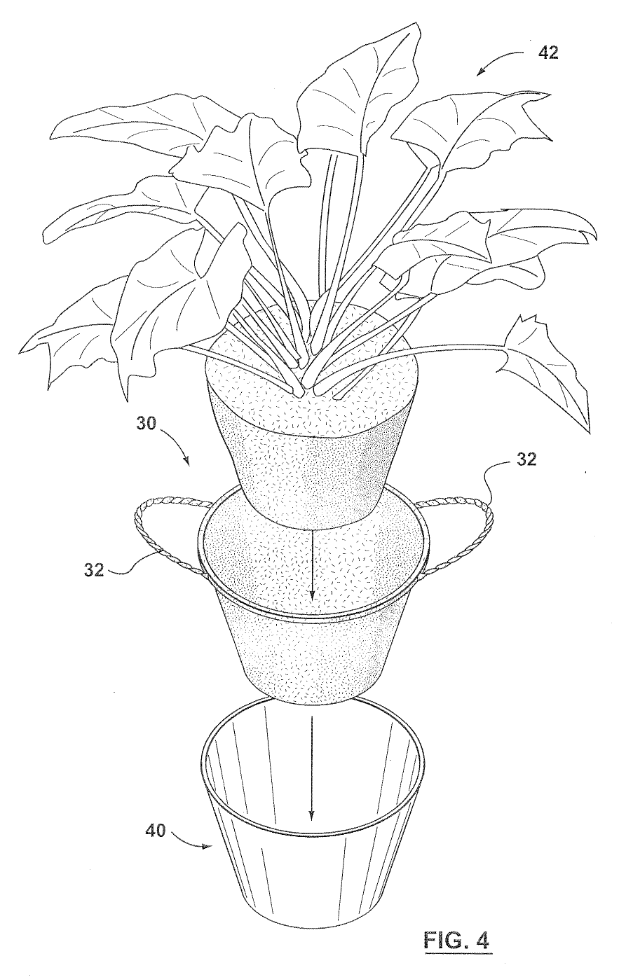

FIG. 4 shows the coir plant container of FIG. 3 in operation.

### DESCRIPTION OF EMBODIMENTS OF THE INVENTION

In accordance with an aspect of the invention, an enhanced rope is provided comprised exclusively of brown coir fibre and natural elements. An example use of the enhanced rope is with tree wraps and for tying root balls with blankets/sheets made from coir fibres, such as the coir fibre blanket/sheet (which is referred to as a tree liner below) forming another aspect of the invention, described below. Such sheets/blankets made of coir fibre and which may be tied with the enhanced coir rope are advantageous as they are slower to biodegrade than burlap tied with hemp rope or other alternatives plus with the use of coir material moisture is retained around the root balls during growth and transportation. Furthermore, as the coir degrades in such blankets and ropes, it enriches the underlying soil providing nutrients in mulch form to establish vegetation. Furthermore, coir fibre is a deterrent to termites and other pests or insects that may cause damage to the tree.

The enhanced rope of the herein invention is comprised of brown coir and has an advantage over known and existing rope materials in that the enhanced rope will generally last 2 to 3 times longer than traditional sisal rope products used today and is stronger yet still flexible and is able to take the full weight of a tree as compared to the other coir rope intended for use in the horticultural industry. The preferred example thickness of the enhanced rope is 5-strands braided or twisted together to result in a thickness of 0.625″ (1.5875 cm). It may be provided in rolls of 1500 foot (457 m) rolls; however any desired length of roll and packaging may be provided. It should be understood that the rope may be a twisted or a braided construction. A preferred example embodiment is made of 100% twisted brown coir fibre and in particular comprising 70% long strands and 30% short strands. Long strands are defined as being coir fibre strands 4″ or more in length. Short strands are defined as being coir fibre strands of less than 4″ in length. In the example shown, no latex or other “chemicals” are used for production of the rope for this purpose.

In accordance with a further aspect of the invention, there is provided a tree liner in the form of a sheet, comprising coir and latex. Preferably, no synthetic chemicals are used in the process of forming the tree-liner, and even the adhesive is natural rubber latex.

In accordance with a further aspect of the invention, there is provided a plant container comprising a sheet having a composition of coir and latex wherein the sheet is formed into a plant-pot shape.

The preferred example of the tree-liner is a form-fitted tree-liner which is used to wrap, cover and protect the roots of young trees and bushes during the lifting, preparation, packaging and shipping process from the nursery to the final user. The tree-liner of the herein invention is environmentally friendly, generally more resilient and lasts 2-3 times longer than any of the current alternatives known and used by the industry. It is particularly useful for packaging and shipping function due to its significant insulative properties.

The preferred tree-liner 10 may be any suitable or desirable size and shape, but a preferred example embodiment is a sheet formed into a “plant/flower-pot shaped” container product depicted in FIG. 1. The tree-liner 10 of this example shape will have the following dimensional variation, namely: Height 20″ to 44″ (50 cm to 112 cm) in one-half inch (1.25 cm) increments; top 16 will be up to 96″ diameter, with a base portion 12 that is proportionate having side walls 14 extend upwardly therefrom at various angles from 0 to 85 degrees but most commonly between a 20 to 30 degree angles. The tree liner 10 may vary in thickness with a preferred range of 0.25 to 0.5″ (0.635 cm to 1.27 cm). Although, it should be understood that the invention does contemplate a greater or lesser thickness than the preferred range described. The plant-pot shape may be achieved by molding a single sheet of latex sprayed coir fibre as further explained below and such as shown in FIG. 1. Alternately, the plant/flower-pot shape may be achieved by attaching a bottom sheet portion of the coir fibre latex sheet to form the bottom portion 12 of the tree liner 10 and attaching it to a second sheet portion of the coir fibre latex sheet which form the peripheral side walls 14 of the tree liner 10 extending from the peripheral edge of the bottom sheet.

In accordance with a preferred embodiment of the invention, the coir tree-liner 10 is manufactured with brown coir material and a natural latex. The tree-liner 10 of the herein invention is somewhat resilient and with resistance to tearing or breakage, thus allowing the plant-pot shaped tree-liner to be placed inside a standard wire root basket 20 and then secured in place by the enhanced rope around the soil immediately surrounding the roots of a young tree 22 or the roots themselves. Such is shown in FIG. 2.

An aspect of a preferred method of manufacture of both the enhanced rope and the coir fibre sheet of the herein inventions is that the brown coir fibre is extracted from the softened coconut husk by soaking the husks in fresh water pits for over four (4) weeks prior to its extraction. In respect of the rope, the desired strands or coir are extracted and formed into the rope. In respect of the coir fibre tree liner 10, the extracted coir fibres are then broken into manageable pieces, formed by roll forming or pressing and/or other suitable means, into its desired thickness and shape and then a liquid rubber latex composition is applied, preferably by spraying over the formed product to hold the pieces together and provide resilience.

The following sets out an example process of manufacture for the tree liner 10:
A) The extracted brown coir fibre strands may be twisted by a Twisting machine into a simple rope format strictly used to simplify transporting to the factory for final processing into a tree liner 10.
B) This machine twisted fibre (“rope”) is fed into a Carding Machine. The Carding Machine will open the twisted fibre.
C) Then a Mat Laying Machine will form the opened rope into a fibre sheet (“fleece”) of coir fibre.
D) The fleece will travel on a conveyer through a Spraying Machine and one side will be sprayed with latex.
E) Then the fleece will travel through a heat chamber which is at a temperature of 80-90 degrees centigrade.
F) The fleece will then be turned over by a Turning Machine and the other side will be sprayed with latex.
G) Once again the fleece will enter the heat chamber and partial drying will take place.
H) Thereafter the fleece will be roller pressed to the required thickness.
I) Then the fleece will be machine rough cut to slightly more than the final required size (“cut sheets”).
J) These cut sheets will be fine cut to the specific template to match the required size for application such as the size of the flower-pot shape tree liner 10.
K) For application as a plant/flower pot shape, these fine cut sheets will be placed in a steel mould to be formed into the “plant/flower-pot” shaped tree liner 10.

Referring to FIG. 3, in other example embodiments there is provided a standalone plant container 30 formed of brown coir. At step K) in the process above, the fine cut sheets are instead stamped or pressed using a stamping or pressing machine into the steel mould into a specified “plant/flower-pot” shape, thereby forming the plant container 30 formed of coir. The sheets are layered to form a suitable thickness and stiffness to maintain a rigid and standalone container, as shown in FIG. 3. This may be accomplished by layering additional layers of the coir sheets (when compared to the tree liner 10) into the mould. Referring now to FIG. 4, the plant container 30 may for example be used for what is commonly referred to as “pot in pot operation”. In such operation, the plant container 30 is inserted into the diameters of a plastic pot 40 which is usually set in the ground. The insertion of the plant container 30 into the plastic pot 40 is for the protection of the plant container 30 against the elements as well as for the anchoring of the plant container 30 until the young plant 42 has grown to a sellable size. Once the young plant 42 has grown to a sellable size the plant container 30 is lifted out of the plastic pot 40 for shipping to clients.

Referring still to FIG. 3, the enhanced rope as described above may also be used to form handle members 32 on the plant container 30. This may for example assist a user in picking up the plant container 30 and any plant contained therein. In one embodiment, the rope is integrated within the plant container 30 by sandwiching between at least two layers of sheets to form the handle member 32 or integrated otherwise. It is also possible for one rope of a suitable length to be used to form both of the handle members 32.

The preferred fibre/latex ratio for the tree liner 10 product and/or plant container 30 is 80% fibre to 20% latex by weight.

The preferred composition of the latex compound as follows includes the below percentage compositions of chemicals which are used to preserve and stabilize the latex: The percentages of the items below are by weight in respect of an example 100 KG of dry compounded latex:

| Item | % of weight |
|---|---|
| Natural Latex | 58% |
| KOH | 0.35% |
| Wettem (see Note 1) | 0.70% |
| Potassium Olate | 0.35% |
| H.S. Emultion | 0.52% |
| ZMBT (Zinc 2-Mercaptobenzothiazole) | 0.26% |
| Mixture C comprising .8% Zno2, | 4.90% |
| 2.8% Sulpher & 1.3% ZDC in the mixture | |
| Clay as filler | 24.00% |
| Water | 10.92% |
| Total | 100% |

Note that Wetten is a registered trademark of Rhodia Chimie for a commercially available surfactant sold under the trade names Mirataine® and Wettem®. Advantageously, said commercially available products can be used as they are, without undergoing an initial treatment to reduce the amount of salt, for example sodium chloride in particular.

In the preferred example embodiments of the tree liner 10, for each 100 kilogram of tree liner material, the final material is by weight 80 Kilograms of coir fibre and 20 Kilograms of latex composition. It should be understood that any known latex compositions including alternate chemical combinations and compositions than described above form an aspect of the invention.

In accordance with certain example embodiments, the pots, rope are 100 percent biodegradable.

In accordance with further aspects of the invention, the coir and latex compositions as described above may be used as stuffing for bedding or as a home insulation product. The use as a home insulation product is particularly advantageous due to the coir's ability to reduce termite populations. Furthermore, the coir and latex compositions may be used to form a hot beverage cup/container, which would be advantageous due to its insulative properties and biodegradability.

It should be understood that many changes, modifications, variations and other uses and applications will become apparent to those skilled in the art after considering the specification and the accompanying drawings. Therefore, any and all such changes, modifications, variations and other uses and applications which do not depart from the scope of the invention are deemed to be covered by the invention.

What is claimed is:

1. A sheet comprising a composition of coir and latex for use in wrapping, covering, shipping and/or protecting the roots of young trees and bushes either by directly engaging the roots or engaging the immediate surrounding soil of the roots.

2. A sheet as recited in claim 1 having a thickness in the range of 0.25 to 0.5 inches.

3. A sheet as recited in claim 2 formed into a flower-pot shape having the following dimensions: Height 20″ to 44″ (50 cm to 112 cm) in one-half inch (1.25 cm) increments; a top having up to a 96″ diameter, with a base portion that is proportionate having side walls extend upwardly therefrom at various angles from 0 to 85 degrees

4. A sheet as recited in claim 3 comprising brown coir material and natural latex.

5. A sheet or container as recited in claim 4 wherein the composition has a fibre/latex ratio of 80% coir fibre to 20% latex by weight.

6. A sheet as recited in claim 4 wherein the latex compound includes the following ingredients in the percentages indicated by weight:

| Item | % of weight |
|---|---|
| Natural Latex | 58% |
| KOH | 0.35% |
| Wettem | 0.70% |
| Potassium Olate | 0.35% |
| H.S. Emultion | 0.52% |
| ZMBT (Zinc 2-Mercaptobenzothiazole) | 0.26% |
| Mixture C comprising | 4.90% |
| Zno2, Sulpher & ZDC in the mixture | |
| Clay as filler | 24.00% |
| Water | 10.92% |
| Total | 100% |

7. A method of manufacturing a sheet comprising coir and latex comprising the following steps: forming by roll-forming or pressing brown coir fibre into its desired thickness; applying a liquid latex composition; and forming the coir fibre latex sheet into a final shape and size.

8. A method as recited in claim 7, further comprising the following steps, prior to forming by roll-forming or pressing: softening coconut husks by wetting; extracting brown coir fibre from the softened coconut husks; twisting the brown coir fibre into transportable sizes; and untwisting the transported fibre.

9. A method as recited in claim 7, further comprising pressing the coir fibre latex sheet into a mould.

10. A method as recited in claim 9, further comprising layering additional coir fibre latex sheets prior to pressing the coir fibre latex sheet into a mould.

11. A plant container comprising at least one sheet having a composition of coir and latex wherein the sheet is formed into a plant-pot shape.

12. A plant container as recited in claim 11 further comprising handle members connected to the plant container and wherein said handle members are composed of coir fibre.

13. A plant container as recited in claim 12 wherein portions of the handle members are integrated within the plant container, being secured thereto.

14. A plant container as recited in claim 12 wherein the handle members are secured to the container by being sandwiched between two sheets which form the container.

15. A plant container as recited in claim 11 wherein the composition has a fibre/latex ratio of 80% coir fibre to 20% latex by weight.
